(19) United States
(12) Patent Application Publication
(10) Pub. No.: US 2005/0281361 A1
(43) Pub. Date: Dec. 22, 2005

(54) Interference cancellation of STBC with multiple streams in OFDM for wlan

(75) Inventor: Joonsuk Kim, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/960,571

(22) Filed: Oct. 8, 2004

Related U.S. Application Data
(60) Provisional application No. 60/579,671, filed on Jun. 16, 2004.

(51) Int. Cl. H04B 7/10

(52) U.S. Cl. 375/347

(57) ABSTRACT

A method of receiving data over M receiving antennas from N streams from K*N transmitting antennas, where M, N and K are integers and M is greater than N, includes the steps of receiving N signals over the M receiving antennas, applying the N signals in pairs to a plurality of decoder modules, removing interference terms between the paired N signals and providing data in a plurality of channels, selecting weighting factors and applying the weighting factors to the plurality of channels and combining the weighted plurality of channels to derive received data.

### REFERENCE TO RELATED APPLICATIONS

This application claims priority of U.S. Provisional Patent Application Ser. No. 60/579,671, filed on Jun. 16, 2004. The subject matter of this earlier filed application is hereby incorporated by reference.

### BACKGROUND OF THE INVENTION

1. Field of Invention

The present invention relates to wireless communication between devices. In particular, the present invention is directed to coding techniques applicable to orthogonal frequency division multiplexing (OFDM) in wireless networking.

2. Description of Related Art

In recent years, there has been rapid growth in mobile computing and other wireless data services, as well as growth in fixed wireless access technologies. These services have the benefit of not requiring wiring between nodes to support the networking and potentially allow for communication where it could be difficult to provide a wired infrastructure. These services can be used to provide high quality telephony, high-speed Internet access, multimedia and other broadband services.

These services provide several challenges in the areas of efficient coding and modulation, quality improving signal processing techniques and techniques for sharing limited spectrum between users. One way to improve the capacity of wireless communication systems is to use multiple transmit and receive antennas. This is often achieved through coding techniques appropriate to multiple antennas, such as through space-time block-coding (STBC).

STBC is a coding technique used with multiple antennas to introduce temporal and spatial correlation into signals transmitted from different antennas, in order to provide diversity at a receiver, and coding gain when compared to an un-coded system, without sacrificing bandwidth. STBC helps increase reliability and can provide full diversity gains with simple linear processing of signals at a receiver. One formulation of STBC involves pairs of antennas which transmit a stream over two transmit antennas achieving a diversity gain with the order of two. Additionally, however, such formulations can be extended to have more than two antennas transmitting a single stream, i.e. three or four or more antennas transmitting the stream, to achieve other types of gains.

The wireless channels used are subject to time-varying problems such as noise, interference and multipath issues. Additionally, for mobile systems, the communications should be accomplished through low power requirements so that the system can be simply powered and remain small and lightweight. This can often preclude signal processing techniques that can be used for reliable communications and efficient spectral utilization, if those techniques demand significant processing power.

As discussed above, when the resources of multiple antennas are available, the spatial domain can be utilized to achieve reliable transmission. In that case, some pairs of antennas are used for diversity gains and some groups used with multiplexing for higher throughputs. With these multiple streams, there is a need for interference cancellation at the receiver. However, the prior art does not provide such interference cancellation techniques for multiple streams.

### SUMMARY OF THE INVENTION

According to one embodiment, a method of receiving data over M receiving antennas from N streams from K*N transmitting antennas is disclosed, where M, N and K are integers and M is greater than N. The method includes the steps of receiving N signals over the M receiving antennas, applying the N signals in pairs to a plurality of decoder modules, removing interference terms between the paired N signals and providing data in a plurality of channels, selecting weighting factors and applying the weighting factors to the plurality of channels and combining the weighted plurality of channels to derive received data.

Additionally, the step of receiving N signals over the M receiving antennas may include receiving two signals over three receiving antennas. The method may include zero-forcing terms equivalent to relationships between signals sent from the K*N transmitting antennas to the M receiving antennas to remove interference terms. For example with N=2, M=3 and K=2, the relationships may be
r₁=H₁c₁+G₁c₂+n₁
r₂=H₂c₁+G₂c₂+n₂ where,
r₃=H₃c₁+G₃c₂+n₃

$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{h}_{3 i} & {h}_{4 i} \\ {h}_{4 i}^{*} & - {h}_{3 i}^{*}\end{matrix} ] ,$$

and information from the plurality of channels comprises;

$$[ \begin{matrix}{\tilde{r}}_{i} \\ {\tilde{r}}_{j}\end{matrix} ] = [ \begin{matrix}{\tilde{H}}_{ij} & 0 \\ 0 & {\tilde{G}}_{ij}\end{matrix} ] [ \begin{matrix}{c}_{1} \\ {c}_{2}\end{matrix} ] + [ \begin{matrix}{\tilde{n}}_{1} \\ {\tilde{n}}_{2}\end{matrix} ] .$$

Also, the selected weighting factors may be of equal value, may be proportional to relationships between signals sent from the K*N transmitting antennas to the M receiving antennas or proportional to relationships between signals sent from the K*N transmitting antennas to the M receiving antennas divided noise values for those relationships. In addition, the method may include determining initial values of the received data and iterating values for the received data recursively until estimations of the received data are stabilized.

According to another embodiment, a receiver for receiving data over M receiving antennas transmitted from N streams from K*N transmitting antennas, where M, N and K are integers and M is greater than N, is disclosed. The receiver includes receiving means for receiving N signals over the M receiving antennas, applying means for applying the N signals in pairs to a plurality of decoder modules, removing means for removing interference terms between the paired N signals and providing data in a plurality of channels, weighting means for selecting weighting factors and applying the weighting factors to the plurality of channels and combining means combining the weighted plurality of channels to derive received data.

According to another embodiment, a receiver for receiving data over M receiving antennas transmitted from N streams from K*N transmitting antennas, where M, N and K are integers and M is greater than N, is disclosed. The receiver includes M receiving antennas, configured to receive N signals, a plurality of decoder modules, configured to receive the N signals in pairs, to remove interference terms between the paired N signals and to provide data in a plurality of channels, weighting units, configured to select weighting factors and to apply the weighting factors to the plurality of channels, and at least one mixer, configured to combine the weighted plurality of channels to derive received data.

These and other variations of the present invention will be described in or be apparent from the following description of the preferred embodiments.

### BRIEF DESCRIPTION OF THE DRAWINGS

For the present invention to be easily understood and readily practiced, the present invention will now be described, for purposes of illustration and not limitation, in conjunction with the following figures:

FIG. 1 provides a schematic illustrating multiple transmitters and a receiver having a multiplicity of antennas, according to one embodiment of the present invention;

FIG. 2 illustrates a schematic of a transmitter circuit, with FIG. 2(a) illustrating modules that produce multiple signals and with FIG. 2(b) illustrating modules for manipulating the multiple signals, according to one embodiment of the present invention;

FIG. 3 illustrates a schematic of a receiver circuit, with FIG. 3(a) illustrating modules that receive multiple signals and with FIG. 3(b) illustrating modules for deriving original data from the multiple signals, according to one embodiment of the present invention;

FIG. 4 provides simulation data showing differences between STBC coding and a minimum mean square error (MMSE), performed with hard decision for Viterbi for channels with a delay spread of 15 ns, according to one embodiment of the present invention; and

FIG. 5 provides simulation data showing differences between STBC coding and a MMSE in another channel, performed with hard decision for Viterbi for channels with a delay spread of 50 ns, according to one embodiment of the present invention;

FIG. 6 provides simulation data showing differences between STBC coding utilizing different weights, performed with hard decision for Viterbi for channels with a delay spread of 15 ns, according to one embodiment of the present invention;

FIG. 7 provides simulation data showing differences between STBC coding utilizing different weights in another channel, performed with hard decision for Viterbi for channels with a delay spread of 50 ns, according to one embodiment of the present invention;

FIG. 8 provides simulation data showing differences between different types of STBC coding, performed with hard decision for Viterbi for channels with a delay spread of 15 ns, according to one embodiment of the present invention; and

FIG. 9 provides simulation data showing differences between different types of STBC coding in another channel, performed with hard decision for Viterbi for channels with a delay spread of 50 ns, according to one embodiment of the present invention.

### DETAILED DESCRIPTION OF PREFERRED EMBODIMENTS

STBC is usually performed in raw symbol domains. Additionally, STBC performs well for a flat channel over two consecutive symbols. Otherwise, the orthogonality between two STBC symbols is broken and the crosstalk remains and this results in an error floor. In order to utilize STBC to obtain the transmit antenna diversity in a frequency selective channel environment, orthogonal frequency division multiplexing (OFDM) is used to provide a flat channel in each tone. It is noted that STBC with OFDM is considered for IEEE 802.11n standards with multiple antennas for reliable transmission.

STBC is usually used to realize transmit antenna diversity. This scheme is useful because it is easy to achieve Maximal Ratio Combining (MRC) by simply channel matching, and you can achieve diversity gain by putting more antennas at the transmitter when the receiver has some limitation of multiple antennas due to either space or power restriction. However, 2xM STBC cannot increase data rates spatially, because it transmits only one stream over space, where M is an integer and equal to the number of receiving antennas. To obtain more data rates, 2NxM STBC scheme may be employed with N multiple streams, and the receiver needs to cancel those N streams between each other. In the present invention, examples discussed involve STBC with pairs of antennas which transmit a stream over two transmit antennas achieving a diversity gain with the order of two. Additionally, however, such formulations can be extended to have more than two antennas transmitting a single stream, i.e. three or four or more antennas transmitting the stream, to achieve other types of gains. The present invention is thus not limited to the 2NxM STBC scheme, but also applicable to a K*NXM STBC scheme, where K is the number of antennas transmitting the stream.

From the prior art, it has been known that there is a tradeoff between diversity and multiplexing. When all of antennas are used for diversity, Nₜₓ*Nᵣₓ orders of Diversity can be achieved, where Nₜₓ is the number of transmit antennas and Nᵣₓ is the number of receive antennas. When two multiple streams are used for multiplexing, (Nₜₓ−1)*(Nᵣₓ−1) orders of diversity can be achieved. This is further discussed in “Diversity and Multiplexing: A Fundamental Tradeoff in Multiple Antenna Channels,” L. Zheng and D. Tse, IEEE Trans. Inform. Theory, Vol. 49(5), May 2003.

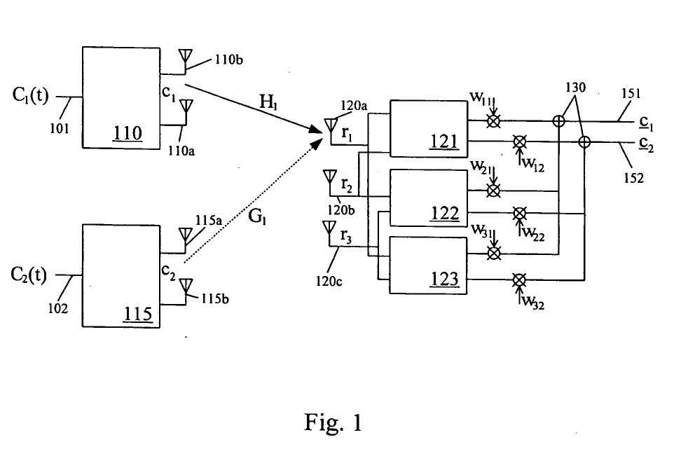

One such system is illustrated in FIG. 1. In that figure, data is received, through 101 and 102, to transmitters 110 and 115. Each transmitter has a pair of antennas, i.e 110a & 110b and 115a & 115b, that transmit the data signals. The signals are received by a receiver having three receive antennas, 120a, 120b and 129c. Each antenna is connected to a decoding module, 121-123, where the resulting signals are weighted and combined, 130, to provide received data signals at 151 and 152.

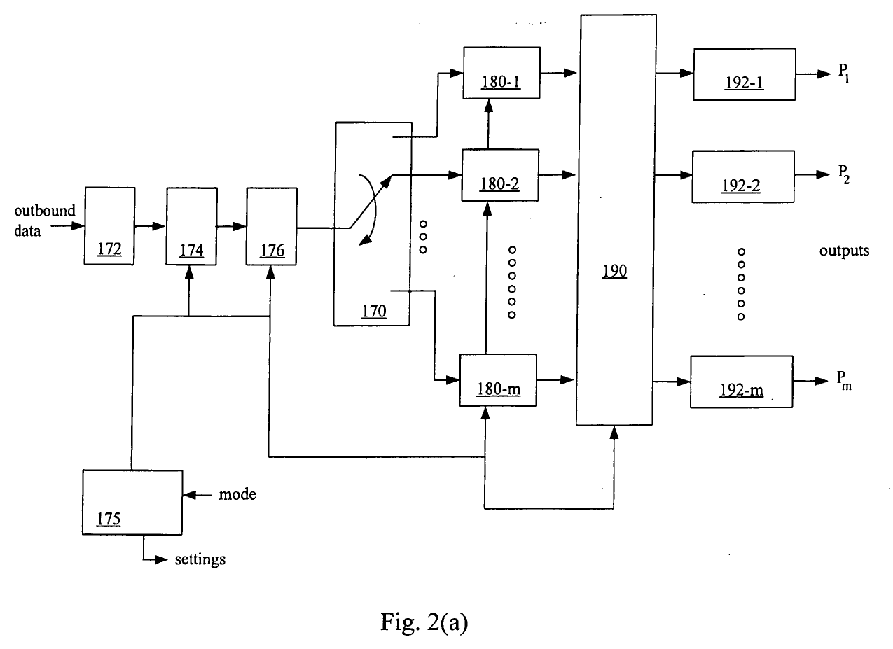

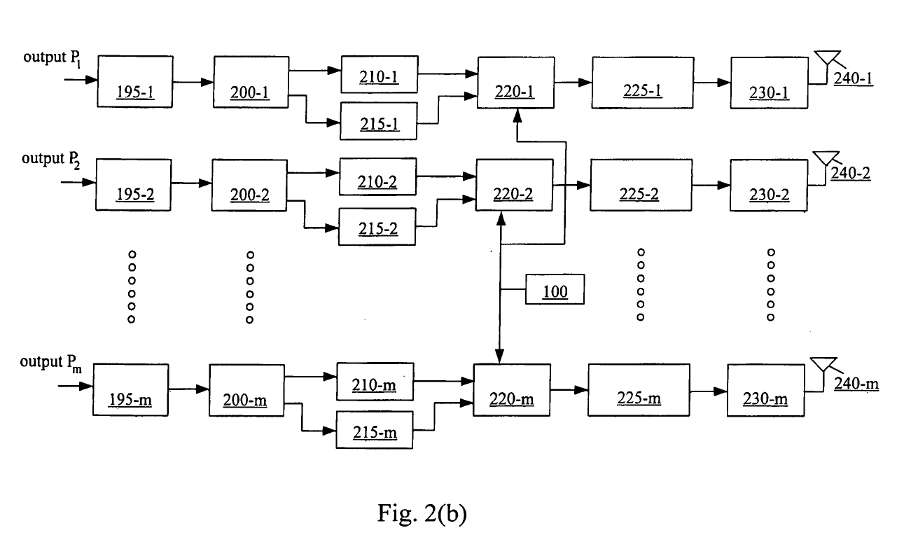

While the above receiver and transmitter are discussed and illustrated generally, more specific discussions of the receiver and transmitter may be necessary to understand the use of coding in wireless networking. FIGS. 2(a) and (b) illustrate a schematic block diagram of a multiple transmitter in accordance with one embodiment of the present invention. In FIG. 2(a), the baseband processing is shown to include a scrambler 172, channel encoder 174, interleaver 176, demultiplexer 170, a plurality of symbol mappers 180-1 through 180-m, a space/time encoder 190, and a plurality of inverse fast Fourier transform (IFFT)/cyclic prefix addition modules 192-1 through 192-m. It is noted that space/time encoder and the IFFT modules may be combined to have a module that performs both functions. The baseband portion of the transmitter may further include a mode manager module 175 that receives the mode selection signal and produces settings for the radio transmitter portion and produces the rate selection for the baseband portion.

In operations, the scrambler 172 adds (in GF2) a pseudo random sequence to the outbound data bits to make the data appear random. A pseudo random sequence may be generated from a feedback shift register with the generator polynomial of S(x)=x⁷+x⁴+1 to produce scrambled data. The channel encoder 174 receives the scrambled data and generates a new sequence of bits with redundancy. This will enable improved detection at the receiver. The channel encoder 174 may operate in one of a plurality of modes. For example, for backward compatibility with IEEE 802.11(a) and IEEE 802.11(g), the channel encoder has the form of a rate 1/2 convolutional encoder with 64 states and a generator polynomials of G₀=133₈ and G₁=171₈. The output of the convolutional encoder may be punctured to rates of 1/2, 2/3rds and 3/4 according to the specified rate tables. For backward compatibility with IEEE 802.11(b) and the CCK modes of IEEE 802.11(g), the channel encoder has the form of a CCK code as defined in IEEE 802.11(b).

For higher data rates, the channel encoder may use the same convolution encoding as described above or it may use a more powerful code, including a convolutional code with more states, a parallel concatenated (turbo) code and/or a low density parity check (LDPC) block code. Further, any one of these codes may be combined with an outer Reed Solomon code. Based on a balancing of performance, backward compatibility and low latency, one or more of these codes may be optimal. As discussed below, the channel information can be derived, and can be used in the decoding process for both turbo and LDPC coding.

The interleaver 176 receives the encoded data and spreads it over multiple symbols and transmit streams. This allows improved detection and error correction capabilities at the receiver. In one embodiment, the interleaver 176 will follow the IEEE 802.11(a) or (g) standard in the backward compatible modes. For higher performance modes, the interleaver will interleave data over multiple transmit streams. The demultiplexer 170 converts the serial interleave stream from interleaver 176 into M-parallel streams for transmission.

Each symbol mapper 180-1 through 180-m receives a corresponding one of the M-parallel paths of data from the demultiplexer. Each symbol mapper 180-m lock maps bit streams to quadrature amplitude modulated QAM symbols (e.g., BPSK, QPSK, 16 QAM, 64 QAM, 256 QAM, et cetera) according to the rate tables. For IEEE 802.11(a) backward compatibility, double gray coding may be used.

The map symbols produced by each of the symbol mappers 180-m are provided to the space/time encoder 190 receives the M-parallel paths of time domain symbols and converts them into output symbols. In one embodiment, the number of M-input paths will equal the number of P-output paths. In another embodiment, the number of output paths P will equal M+1 paths. For each of the paths, the space/time encoder multiples the input symbols with an encoding matrix that has the form of, for K=2:

$$[ \begin{matrix}{C}_{1} & {C}_{2} & {C}_{3} & ⋯ & {C}_{2 M - 1} \\ - {C}_{2}^{*} & {C}_{1}^{*} & {C}_{4} & ⋯ & {C}_{2 M}\end{matrix} ]$$

It is noted that the rows of the encoding matrix correspond to the number of input paths and the columns correspond to the number of output paths. For other K values, the matrices would be different:

$$\begin{matrix}[ \begin{matrix}{C}_{1} & - {C}_{2}^{*} & {C}_{3}^{*} & … & {C}_{3 M}^{*} \\ - {C}_{2} & - {C}_{3}^{*} & {C}_{1}^{*} & … & {C}_{( 3 M - 2 )}^{*} \\ - {C}_{3} & {C}_{1}^{*} & {C}_{2}^{*} & … & {C}_{( 3 M - 1 )}^{*}\end{matrix} ] , for K = 3 \\ [ \begin{matrix}{C}_{1} & - {C}_{2}^{*} & - {C}_{3}^{*} & {C}_{4} & … & {C}_{4 M} \\ {C}_{2} & {C}_{1}^{*} & - {C}_{4}^{*} & - {C}_{3} & … & - {C}_{( 4 M - 1 )} \\ {C}_{3} & - {C}_{4}^{*} & {C}_{1}^{*} & - {C}_{2} & … & - {C}_{( 4 M - 2 )} \\ {C}_{4} & {C}_{3}^{*} & {C}_{2}^{*} & {C}_{1} & … & {C}_{( 4 M - 3 )}\end{matrix} ] , for K = 4\end{matrix}$$

The outputs of the space/time encoder 190 are introduced into IFFT/cyclic prefix addition modules 192-1 through 192-m, which perform frequency domain to time domain conversions and add a prefix, which allows removal of inter-symbol interference at the receiver. It is noted that the length of the IFFT and cyclic prefix are defined in mode tables. In general, a 64-point IFFT will be used for 20 MHz channels and 128-point IFFT will be used for 40 MHz channels.

FIG. 2(b) illustrates the radio portion of the transmitter that includes a plurality of digital filter/up-sampling modules 195-1 through 195-m, digital-to-analog conversion modules 200-1 through 200-m, analog filters 210-1 through 210-m and 215-1 through 215-m, I/Q modulators 220-1 through 220-m, RF amplifiers 225-1 through 225-m, RF filters 230-1 through 230-m and antennas 240-1 through 240-m. The P-outputs from the space/time encoder 192 are received by respective digital filtering/up-sampling modules 195-1 through 195-m.

In operation, the number of radio paths that are active correspond to the number of P-outputs. For example, if only one P-output path is generated, only one of the radio transmitter paths will be active. As one of average skill in the art will appreciate, the number of output paths may range from one to any desired number.

The digital filtering/up-sampling modules 195-1 through 195-m, filter the corresponding symbols and adjust the sampling rates to correspond with the desired sampling rates of the digital-to-analog conversion modules 200-1 through 200-m. The digital-to-analog conversion modules 200 convert the digital filtered and up-sampled signals into corresponding in-phase and quadrature analog signals. The analog filters 210 and 215 filter the corresponding in-phase and/or quadrature components of the analog signals, and provide the filtered signals to the corresponding I/Q modulators 220-1 through 220-m. The I/Q modulators 220, based on a local oscillation, which is produced by a local oscillator 100, up-converts the I/Q signals into radio frequency signals. The RF amplifiers 225-1 through 225-m amplify the RF signals which are then subsequently filtered via RF filters 230-1 through 230-m before being transmitted via antennas 240-1 through 240-m.

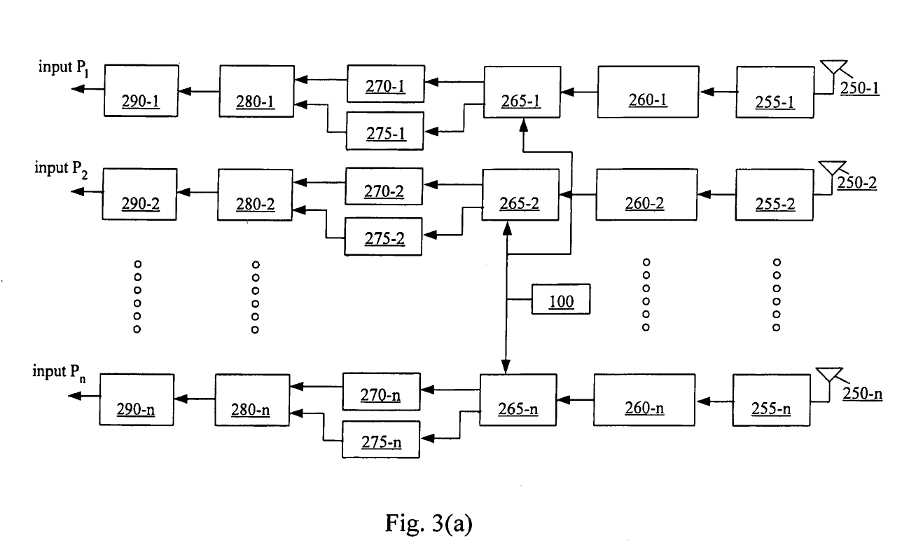

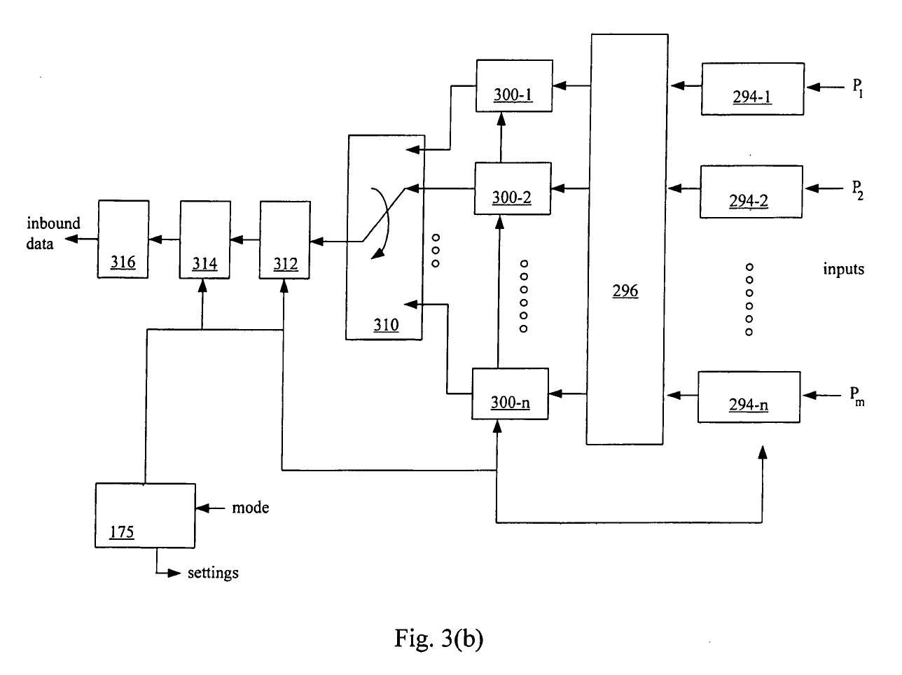

FIGS. 3(a) and 3(b) illustrate a schematic block diagram of another embodiment of a receiver in accordance with the present invention. FIG. 3(a) illustrates the analog portion of the receiver which includes a plurality of receiver paths. Each receiver path includes an antenna, 250-1 through 250-n, RF filters 255-1 through 255-n, low noise amplifiers 260-1 through 260-n, I/Q demodulators 265-1 through 265-n, analog filters 270-1 through 270-n and 275-1 through 275-n, analog-to-digital converters 280-1 through 280-n and digital filters and down-sampling modules 290-1 through 290-n.

In operation, the antennas 250 receive inbound RF signals, which are band-pass filtered via the RF filters 255. The corresponding low noise amplifiers 260 amplify the filtered signals and provide them to the corresponding I/Q demodulators 265. The I/Q demodulators 265, based on a local oscillation, which is produced by local oscillator 100, down-converts the RF signals into baseband in-phase and quadrature analog signals.

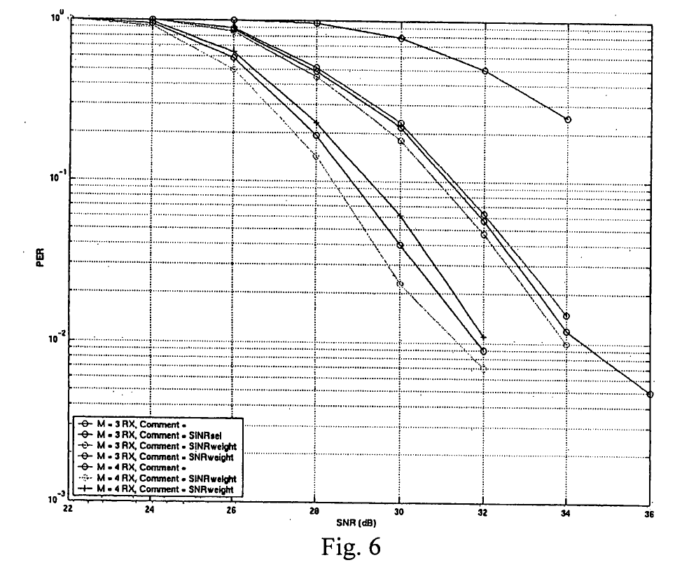

The corresponding analog filters 270 and 275 filter the in-phase and quadrature analog components, respectively. The analog-to-digital converters 280 convert the in-phase and quadrature analog signals into a digital signal. The digital filtering and down-sampling modules 290 filter the digital signals and adjust the sampling rate to correspond to the rate of the baseband processing, which will be described in FIG. 6B.

FIG. 3(b) illustrates the baseband processing of a receiver. The baseband processing includes a plurality of fast Fourier transform (FFT)/cyclic prefix removal modules 294-1 through 294-n, a space/time decoder 296, a plurality of symbol demapping modules 300-1 through 300-n, a multiplexer 310, a deinterleaver 312, a channel decoder 314, and a descramble module 316. The baseband processing module may further include a mode managing module 175. The N paths are processed via the FFT/cyclic prefix removal modules 294-1 through 294-n which perform the inverse function of the IFFT/cyclic prefix addition modules 192-1 through 192-n to produce frequency domain symbols. The space/time decoding module 296, which performs the inverse function of space/time encoder 190, receives P-inputs from the FFT/cyclic prefix removal modules and produce N-output paths.

The symbol demapping modules 300 convert the frequency domain symbols into data utilizing an inverse process of the symbol mappers 180. The multiplexer 310 combines the demapped symbol streams into a single path. The deinterleaver 312 deinterleaves the single path utilizing an inverse function of the function performed by interleaver 176. The deinterleaved data is then provided to the channel decoder 314 which performs the inverse function of channel encoder 174. The descrambler 316 receives the decoded data and performs the inverse function of scrambler 172 to produce the inbound data 98.

Assuming such a system, the system with N=2, M=3 and K=2, as illustrated in FIG. 1, may be represented, according to at least one embodiment, by the following equation:
r₁=H₁c₁+G₁c₂+n₁
r₂=H₂c₁+G₂c₂+n₂
r₃=H₃c₁+G₃c₂+n₃ (1)
where,

$$\begin{matrix}{H}_{i} = [ \begin{matrix}{h}_{1 i} & {h}_{2 i} \\ {h}_{2 i}^{*} & - {h}_{1 i}^{*}\end{matrix} ] , & & {G}_{i} = [ \begin{matrix}{h}_{3 i} & {h}_{4 i} \\ {h}_{4 i}^{*} & - {h}_{3 i}^{*}\end{matrix} ]\end{matrix} \qquad ( 2 )$$

Two rᵢ out of the three rᵢ are selected and Zero-Forcing is applied to cancel the interference. This results in:

$$[ \begin{matrix}I & - {G}_{i} {G}_{j}^{- 1} \\ - {H}_{j} {H}_{i}^{- 1} & I\end{matrix} ] [ \begin{matrix}{r}_{i} \\ {r}_{j}\end{matrix} ] = [ \begin{matrix}{\tilde{r}}_{i} \\ {\tilde{r}}_{j}\end{matrix} ] = [ \begin{matrix}{\tilde{H}}_{ij} & 0 \\ 0 & {\tilde{G}}_{ij}\end{matrix} ] [ \begin{matrix}{c}_{1} \\ {c}_{2}\end{matrix} ] + [ \begin{matrix}{\tilde{n}}_{1} \\ {\tilde{n}}_{2}\end{matrix} ] \qquad ( 3 )$$

With STBC of two multiple streams and N=2 and K=2 (i.e., Nₜₓ=4), and M=3 (i.e., Nᵣₓ=3), two receive antennas out of three can be selected (i.e., ₃C₂=3 combinations) to cancel two multiple streams. In other words, to decode STBC stream c1 and c2, (R×1, R×2) or (R×1,R×3) or (R×2, R×3) may be selected. However, diversity gain is (N−1)*(M−1)=2, which means these three combinations have one redundancy. If this redundancy has good quality (nice separation of interference), then it helps STBC decoding, but if it has bad quality (interference cannot be cancelled), STBC performs worse. There are three ways to utilize this redundancy to improve the signal quality.

The outputs after cancellation can be combined through weighting:
c₁=w₁₁c₁₁+w₂₁c₂₁+w₃₁c₃₁
c₂=w₁₂c₁₂+w₂₂c₂₂+w₃₂c₃₂ (4)
In eq. (4), cᵢⱼ is sliced from cⱼ in eq. (3), when i denotes the number of combinations to choose from ₘCₙ combinations and the j is the stream number, up to N, the number of streams. In the above-described example, with M=3 and N=2, there are ₃C₂=3 combinations such that i=1, 2 & 3 and j=1 & 2.

The weights used in the process can be chosen in a variety of ways, according to different embodiments of the invention. One selection may have wᵢⱼ=1 for all i,j, i.e., equal gain weighting. Another would be to set wᵢⱼ=1 for i=argmax(abs(Hᵢ)) or i=argmax(abs(Gᵢ)). This is referred to, herein, as selection weighting, which is basically to choose one set of combinations out of all possible ₘCₙ combinations. Additionally, wᵢⱼ may be calculated depending on interference cancellation (either noise enhancement or channel condition number), where wᵢⱼ are proportional to Hᵢ or Gⱼ, or the same quantities divided by noise nᵢ, or referred herein as weighting by SNR and SINR, respectively. Other weighting schemes are also possible and can be implemented according to the instant invention.

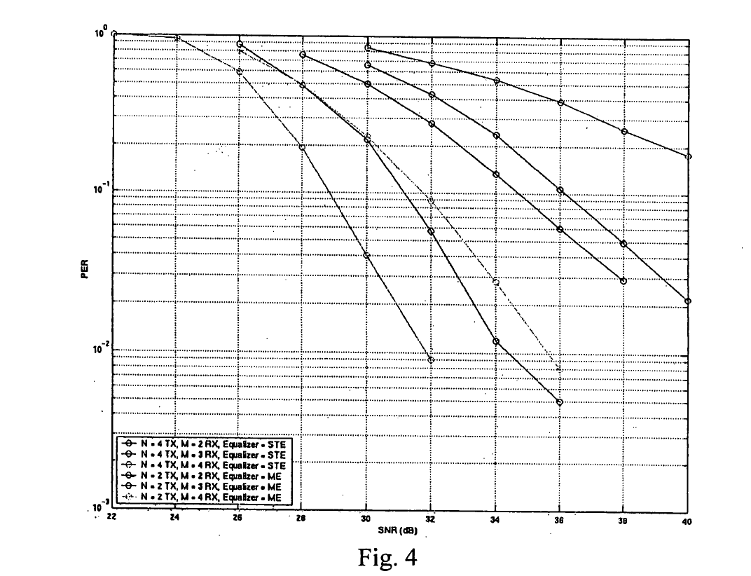

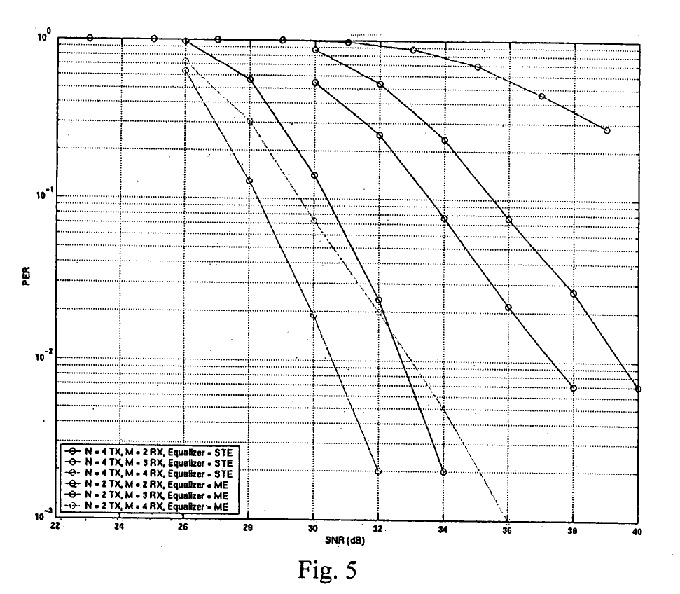

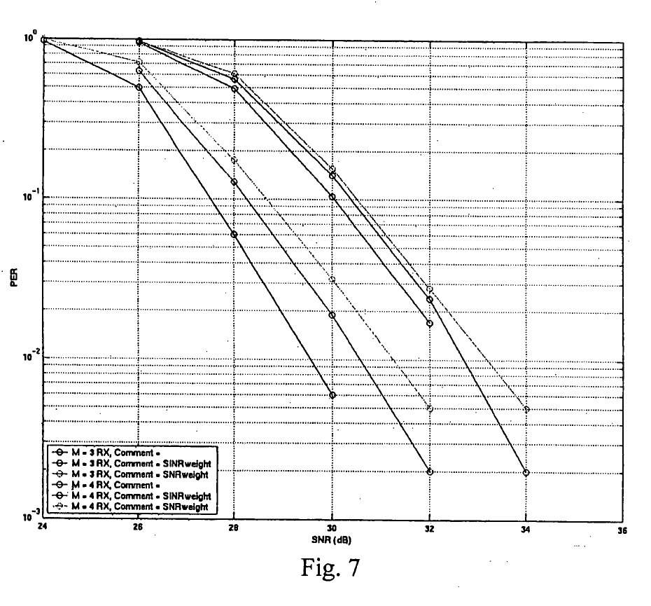

FIGS. 4-7 provide simulation results illustrating benefits of the instant invention. FIGS. 4 and 5 provide responses showing differences between STBC coding and a minimum mean square error (MMSE). The results assume four or two transmitting antennas, at a frequency of 5 GHz, having a bandwidth of 20 MHz, operating under IEEE 802.11n, for two, three and four receive antennas at a distance of approximately 15 meters. FIGS. 6 and 7 provide, showing differences between STBC coding utilizing different weights, as discussed above.

Alternatively, the interference between the signals, in this example for N=2, can be cancelled through subtraction:

$$\begin{matrix}{\tilde{c}}_{1} = slice [ \frac{1}{diag ( {\sum }_{i = 1}^{M} {H}_{i}^{*} {H}_{i} )} \times {\sum }_{i = 1}^{M} {H}_{i}^{*} ( {r}_{i} - {G}_{i} \times {\tilde{c}}_{2} ) ] \\ {\tilde{c}}_{2} = slice [ \frac{1}{diag ( {\sum }_{i = 1}^{M} {G}_{i}^{*} {G}_{i} )} \times {\sum }_{i = 1}^{M} {G}_{i}^{*} ( {r}_{i} - {H}_{i} \times {\tilde{c}}_{1} ) ]\end{matrix} \qquad ( 5 )$$

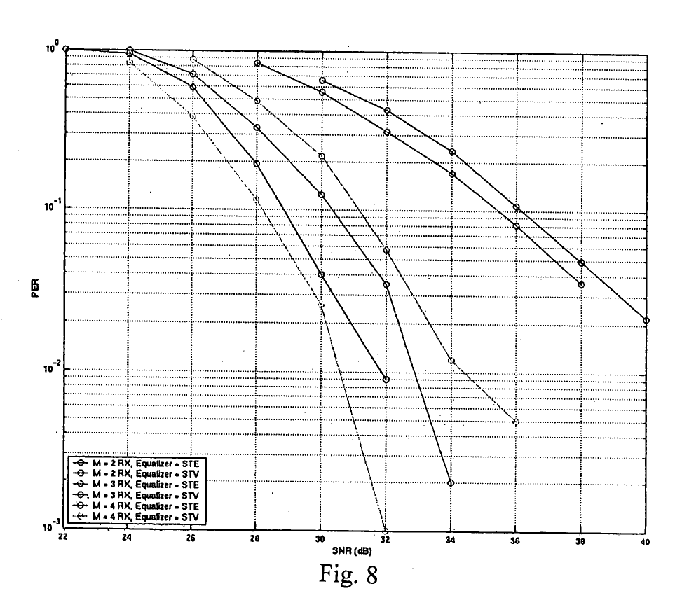

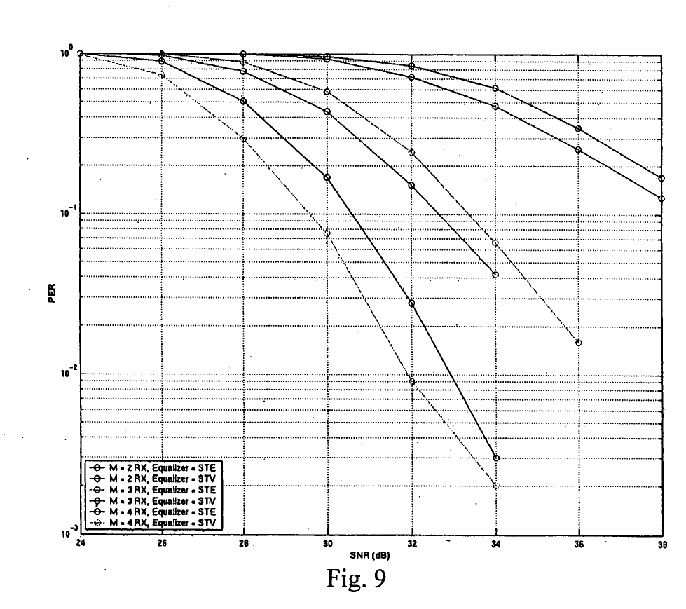

Such a process can allow c₁ and c₂ through iteration. The initial values of c₁ and c₂ can be found through the first, above-discussed method and then iterated until estimations of c₁ and c₂ are stabilized. The ordering of the iteration, because the values are dependent on each other through equation (5), can be made through examination of the signals, determining whether Gᵢ is greater than Hᵢ or vice versa. The results of using the first, above-discussed method, when compared with using both methods consecutively, are illustrated in FIGS. 8 and 9, for different channels.

As discussed and illustrated above, STBC works better than MMSE up to 3 dB at PER of 10%, with the gain coming from transmission diversity. STBC with SINR weights performs better, up to 1 dB, than other weights for receives having a greater number of antennas than a transmitter. The latter iterative process provides superior results than the first method alone, with a benefit of up to 1 dB at PER of 10%.

Accordingly, STBC works better than MMSE up to 3 dB at PER of 10%, where the gain comes from transmission diversity. This gap is slightly bigger for soft decision, as illustrated in the results discussed above. STBC with soft decision outperforms STBC with hard decision up to 5 dB at PER of 10%, as illustrated in FIGS. 4 and 5. STBC with soft decision with N=2, M=4 achieves 10% PER at SNR of 25 dB for 802.11n channel model B. STBC with SINR weight performs better (up to 1 dB) than any other weights when M>N.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method of receiving data over M receiving antennas from N streams from K*N transmitting antennas, where M, N and K are integers and M is greater than N, the method comprising the steps of:
receiving N signals over the M receiving antennas;
applying the N signals in pairs to a plurality of decoder modules;
removing interference terms between the paired N signals and providing data in a plurality of channels;
selecting weighting factors and applying the weighting factors to the plurality of channels; and
combining the weighted plurality of channels to derive received data.

2. A method according to claim 1, wherein the step of receiving N signals over the M receiving antennas comprises receiving two signals over three receiving antennas.

3. A method according to claim 1, wherein the step of removing interference terms comprises zero-forcing terms equivalent to relationships between signals sent from the K*N transmitting antennas to the M receiving antennas to remove interference terms.

4. A method according to claim 3, wherein the relationships comprise:
r₁=H₁c₁+G₁c₂+n₁
r₂=H₂c₁+G₂c₂+n₂ where,
r₃=H₃c₁+G₃c₂+n₃
$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{h}_{3 i} & {h}_{4 i} \\ {h}_{4 i}^{*} & - {h}_{3 i}^{*}\end{matrix} ] ,$$
and information from the plurality of channels comprises;
$$[ \begin{matrix}{\tilde{r}}_{i} \\ {\tilde{r}}_{j}\end{matrix} ] = [ \begin{matrix}{\tilde{H}}_{ij} & 0 \\ 0 & {\tilde{G}}_{ij}\end{matrix} ] [ \begin{matrix}{c}_{1} \\ {c}_{2}\end{matrix} ] + [ \begin{matrix}{\tilde{n}}_{1} \\ {\tilde{n}}_{2}\end{matrix} ] .$$

5. A method according to claim 1, wherein the step of selecting weighting factors comprises selecting weighting factors of equal value.

6. A method according to claim 1, wherein the step of selecting weighting factors comprises selecting weighting factors proportional to relationships between signals sent from the K*N transmitting antennas to the M receiving antennas.

7. A method according to claim 6, wherein the step of selecting weighting factors comprises selecting weighting factors proportional to relationships between signals sent from the K*N transmitting antennas to the M receiving antennas divided noise values for those relationships.

8. A method according to claim 1, further comprising determining initial values of the received data and iterating values for the received data recursively until estimations of the received data are stabilized.

9. A receiver for receiving data over M receiving antennas transmitted from N streams from K*N transmitting antennas, where M, N and K are integers and M is greater than N, comprising:
receiving means for receiving N signals over the M receiving antennas;
applying means for applying the N signals in pairs to a plurality of decoder modules;
removing means for removing interference terms between the paired N signals and providing data in a plurality of channels;
weighting means for selecting weighting factors and applying the weighting factors to the plurality of channels; and
combining means combining the weighted plurality of channels to derive received data.

10. A receiver according to claim 9, wherein the removing means comprises zero-forcing means for zero-forcing terms equivalent to relationships between signals sent from the K*N transmitting antennas to the M receiving antennas to remove interference terms.

11. A receiver according to claim 10, wherein the relationships comprise:
r₁=H₁c₁+G₁c₂+n₁
r₂=H₂c₁+G₂c₂+n₂ where,
r₃=H₃c₁+G₃c₂+n₃
$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{h}_{3 i} & {h}_{4 i} \\ {h}_{4 i}^{*} & - {h}_{3 i}^{*}\end{matrix} ] ,$$
and information from the plurality of channels comprises;
$$[ \begin{matrix}{\tilde{r}}_{i} \\ {\tilde{r}}_{j}\end{matrix} ] = [ \begin{matrix}{\tilde{H}}_{ij} & 0 \\ 0 & {\tilde{G}}_{ij}\end{matrix} ] [ \begin{matrix}{c}_{1} \\ {c}_{2}\end{matrix} ] + [ \begin{matrix}{\tilde{n}}_{1} \\ {\tilde{n}}_{2}\end{matrix} ] .$$

12. A receiver according to claim 9, wherein the weighting means comprises means for selecting weighting factors of equal value.

13. A receiver according to claim 9, wherein the weighting means comprises means for selecting weighting factors proportional to relationships between signals sent from the K*N transmitting antennas to the M receiving antennas.

14. A receiver according to claim 13, wherein the weighting means comprises means for selecting weighting factors proportional to relationships between signals sent from the K*N transmitting antennas to the M receiving antennas divided noise values for those relationships.

15. A receiver according to claim 9, further comprising determining means for determining initial values of the received data and iterating means for iterating values for the received data recursively until estimations of the received data are stabilized.

16. A receiver for receiving data over M receiving antennas from N streams transmitted by K*N transmitting antennas, where M, N and K are integers and M is greater than N, the receiver comprising:
M receiving antennas, configured to receive N signals;
a plurality of decoder modules, configured to receive the N signals in pairs, to remove interference terms between the paired N signals and to provide data in a plurality of channels;
weighting units, configured to select weighting factors and to apply the weighting factors to the plurality of channels; and
at least one mixer, configured to combine the weighted plurality of channels to derive received data.

17. A receiver according to claim 16, wherein the plurality of decoder modules are configured to remove interference terms through zero-forcing terms equivalent to relationships between signals sent from the K*N transmitting antennas to the M receiving antennas to remove interference terms.

18. A receiver according to claim 17, wherein the relationships comprise:
r₁=H₁c₁+G₁c₂+n₁
r₂=H₂c₁+G₂c₂+n₂ where,
r₃=H₃c₁+G₃c₂+n₃
$${H}_{i} = [ \begin{matrix}{h}_{1 i} & {h}_{2 i} \\ {h}_{2 i}^{*} & - {h}_{1 i}^{*}\end{matrix} ] , {G}_{i} = [ \begin{matrix}{h}_{3 i} & {h}_{4 i} \\ {h}_{4 i}^{*} & - {h}_{3 i}^{*}\end{matrix} ] ,$$
and information from the plurality of channels comprises;
$$[ \begin{matrix}{\tilde{r}}_{i} \\ {\tilde{r}}_{j}\end{matrix} ] = [ \begin{matrix}{\tilde{H}}_{ij} & 0 \\ 0 & {\tilde{G}}_{ij}\end{matrix} ] [ \begin{matrix}{c}_{1} \\ {c}_{2}\end{matrix} ] + [ \begin{matrix}{\tilde{n}}_{1} \\ {\tilde{n}}_{2}\end{matrix} ] .$$

19. A receiver according to claim 16, wherein the weighting units are configured to select weighting factors of equal value.

20. A receiver according to claim 16, wherein the weighting units are configured to select weighting factors proportional to relationships between signals sent from the K*N transmitting antennas to the M receiving antennas.

21. A receiver according to claim 20, wherein the weighting units are configured to select weighting factors proportional to relationships between signals sent from the K*N transmitting antennas to the M receiving antennas divided noise values for those relationships.

22. A receiver according to claim 16, wherein the plurality of decoder modules are configured to determine initial values of the received data and iterate values for the received data recursively until estimations of the received data are stabilized.
